(19) United States
(12) Patent Application Publication
(10) Pub. No.: US 2007/0253468 A1
(43) Pub. Date: Nov. 1, 2007

(54) Spread Spectrum ASK/OOK Transmitter

(75) Inventors: Stale Pettersen, Mjondalen (NO); Stein Eskerud, Nesbru (NO)

Correspondence Address: PATENT LAW GROUP LLP, 2635 NORTH FIRST STREET, SUITE 223, SAN JOSE, CA, 95134, US

(73) Assignee: Micrel Inc., San Jose (CA)

(21) Appl. No.: 11/381,072

(22) Filed: May 1, 2006

(51) Int. Cl. H04B 1/00

(52) U.S. Cl. 375/146

(57) ABSTRACT

An ASK/OOK transmitter includes a frequency-shift keying (FSK) modulator receiving an input bit sequence and generating a FSK modulation signal indicative of the input bit sequence, a frequency generation circuit receiving the FSK modulation signal and generating a carrier signal having a first frequency where the frequency of the carrier signal is shifted by the FSK modulation signal to form a wideband carrier signal, an amplitude-shift keying (ASK) modulator receiving input data and generating an ASK modulation signal indicative of the input data, and a power amplifier coupled to receive the wideband carrier signal as an input signal and the ASK modulation signal as a control signal. The power amplifier provides a spread spectrum ASK transmission signal where the ASK modulation signal modulates the wideband carrier signal to form the spread spectrum ASK transmission signal.

### FIELD OF THE INVENTION

The invention relates to radio frequency transmission methods and, in particular, to a spread spectrum transmission method and transmitter supporting amplitude shift keyed/on-off keyed modulation.

### DESCRIPTION OF THE RELATED ART

Communication via radio frequency (“RF”) devices is regulated by national and international regulatory agencies in order to ensure maximum utilization of limited spectral resources and to minimize interference. In the United States of America, the Federal Communication Commission (“FCC”) regulates and licenses specific portions of radio frequency spectrum or bands for broadcast and other forms of RF communication.

A number of bands have been set aside for “Industrial Scientific and Medical” use, or the (“ISM”) bands by the FCC. Utilization of these bands are unlicensed but is regulated by the FCC. For example, the 900 MHz band is used by a number of consumer wireless devices, physical layer operate in 2.4 GHz. Another unlicensed band is at 5.9 GHz.

The FCC regulation governing these ISM bands are documented in “Operation with the bands 902-928 MHz, 2400-2483.5 MHz and 5725-5875 MHz”, Title 47 Part 15 Section 247) Code of Federal Regulations (47 CFR 15.247). The regulation stipulates the operation of either a frequency hopping or direct sequence spread spectrum intentional radiators. The regulation is based on consideration of reusing the same bands in multiple locations. When implementing with spread spectrum schemes the regulation specifies specific power spectrum density that the intentional radiator must be adhered to.

More specifically, under FCC regulations, spread spectrum transmitters are allowed to have higher output power than narrowband transmitters. There are no restrictions on the actual coding of the information content itself. The regulations only specify the minimum bandwidth of the transmitted spectrum.

Frequency hopping spread spectrum (FHSS) intended radiators transmission refers to a transmission method where the data signal is modulated with a narrowband carrier signal that “hops” in a random but predictable sequence from frequency to frequency as a function of time over a wide band of frequencies. The signal energy is spread in time domain rather than chopping each bit into small pieces in the frequency domain. This technique reduces interference because a signal from a narrowband system will only affect the spread spectrum signal if both are transmitting at the same frequency at the same time. The transmission frequencies are determined by a spreading, or hopping, code. The receiver must be set to the same hopping code and must listen to the incoming signal at the right time and correct frequency in order to properly receive the signal. Current FCC regulations require manufacturers to use 25 or more frequencies with a maximum dwell time (the time spent at a particular frequency during any single hop) of 400 ms. The biggest disadvantage of frequency hopping spread spectrum transmissions is the needed frequency synchronization between the transmitter and the receiver. The frequency synchronization requirement results in a slow access time and high power consumption.

Another form of spread spectrum transmission is referred to as digital modulation or direct-sequence spread spectrum (DSSS). DSSS is a transmission method where a data signal at the sending station is combined with a higher data rate bit sequence, or chipping code, that divides the user data according to a spreading ratio. The chipping code is a redundant bit pattern for each bit that is transmitted, which increases the signal's resistance to interference. If one or more bits in the pattern are damaged during transmission, the original data can be recovered due to the redundancy of the transmission. DSSS radios have a short access time since the channel is stationary. The disadvantage of a DSSS radio is fairly complex demodulation scheme since the received signal needs de-spreading and synchronization.

Amplitude-shift keying (ASK) is a form of modulation which represents digital data as variations in the amplitude of a carrier wave. The simplest and most common form of ASK operates as a switch, using the presence of a carrier wave to indicate a binary one and its absence to indicate a binary zero. This type of modulation is called on-off keying (OOK). Amplitude-shift keying requires a high signal-to-noise ratio for their recovery, as by their nature much of the signal is transmitted at reduced power. The advantage of ASK radio systems is the simplicity of the transceiver topology and low current consumption.

ASK/OOK is a simple, yet powerful modulation scheme and is cost effective to implement both for the transmitter as well as the receiver using silicon technology. Unfortunately, ASK/OOK modulation has low data rate (about 10 Kbps). To be classified as spread spectrum, the data rate of an ASK/OOK modulated signal has to be increased to a level beyond the capability of typical low cost short-range radios.

More specifically, in an ASK modulation system, the occupied bandwidth is less than 500 kHz. So if the output power of the transmitter is increased to higher than −1 dBm, the transmitter has to frequency hop in order to fall within the FCC spread spectrum transmission standard. Spread Spectrum transmitters using low complexity ASK/OOK modulation has been described by U.S. Patent Application Publication No. 2004/0198363 A1. In the '363 patent application, the frequency hopping form of spread spectrum transmission is used. In that case, a narrow band carrier signal uses amplitude shift keying to encode the data, then frequency hop is applied to the carrier signal to obtain a wide transmission spectrum for the transmitted signal. Spread spectrum ASK/OOK transmission implemented using Frequency Hopping form of spread spectrum (FHSS). FHSS adds a lot of complexity to the transmitter and receiver design and requires frequency synchronization between the transmitter and the receiver. In many applications, the additional power consumption required to perform system frequency synchronization is not wanted or possible.

### SUMMARY OF THE INVENTION

According to one embodiment of the present invention, an ASK/OOK transmitter includes a frequency-shift keying (FSK) modulator receiving an input bit sequence and generating a FSK modulation signal indicative of the input bit sequence, a frequency generation circuit receiving the FSK modulation signal and generating a carrier signal having a first frequency where the frequency of the carrier signal is shifted by the FSK modulation signal to form a wideband carrier signal, an amplitude-shift keying (ASK) modulator receiving input data and generating an ASK modulation signal indicative of the input data, and a power amplifier coupled to receive the wideband carrier signal as an input signal and the ASK modulation signal as a control signal. The power amplifier provides a spread spectrum ASK transmission signal where the ASK modulation signal modulates the wideband carrier signal to form the spread spectrum ASK transmission signal.

In one embodiment, the wideband carrier signal has an occupied bandwidth of 500 kHz or more and the power amplifier provides the spread spectrum ASK modulation signal having an output power of or greater than −1 dBm. In another embodiment, the FSK modulation signal has a peak frequency deviation that results in an occupied bandwidth of 500 kHz or greater.

According to another aspect of the present invention, a method of generating a spread spectrum ASK/OOK transmission signal includes providing an input bit sequence, generating a frequency-shift keying (FSK) modulation signal indicative of the input bit sequence, generating a carrier signal having a first frequency, shifting the frequency of the carrier signal using the FSK modulation signal to form a wideband carrier signal, receiving input data, generating an ASK modulation signal indicative of the input data, and amplifying and modulating the wideband carrier signal using the ASK modulation signal, thereby generating a spread spectrum ASK transmission signal.

The present invention is better understood upon consideration of the detailed description below and the accompanying drawings.

### BRIEF DESCRIPTION OF THE DRAWINGS

FIG. 1 is a block diagram of a spread spectrum ASK/OOK transmitter according to one embodiment of the present invention.

FIG. 2 is a detail schematic diagram of a spread spectrum ASK/OOK transmitter according to one embodiment of the present invention.

FIG. 3 is a flow chart illustrating the operation of the spread spectrum ASK/OOK transmitter according to one embodiment of the present invention.

FIG. 4 is a signal waveform of a frequency-shift keying (FSK) modulation signal according to one embodiment of the present invention.

FIG. 5 is a signal waveform of an ASK modulated signal according to one embodiment of the present invention.

FIG. 6 is a frequency spectrum of an FSK-dithered spread spectrum ASK/OOK transmission signal when the FSK modulation signal of FIG. 4 is applied to the ASK modulated signal of FIG. 5.

### DETAILED DESCRIPTION OF THE PREFERRED EMBODIMENTS

In accordance with the principles of the present invention, a spread spectrum ASK/OOK transmission scheme generates transmission signals by dithering the ASK/OOK carrier signal with a frequency-shift keying (FSK) modulation component. The resulting frequency spectrum of the transmitted signal becomes wider and can therefore qualify as Spread Spectrum transmission under the requirements of FCC regulations, such as FCC 47 section 15.247 for communication systems using digital modulation. FSK modulation is easy to generate on the transmitter side but complex to detect on the receiver side. However, in accordance with the present invention, all the information content resides in the ASK/OOK signal component. Therefore, it is not necessary for the receiver to detect the FSK component of the transmitted signal at all. Thus, the transmitter, receiver or transceiver for generating-transmitting and receiving-detecting the spread spectrum ASK/OOK signals of the present invention can be implemented using simplified hardware to realize a simple and low cost communication system with high output power and long transmission range.

In operation, a narrowband ASK/OOK carrier signal is dithered with a FSK modulation component. The FSK/ASK modulated signal can have a data rate up to 200 Kbps. The FSK component of the spread spectrum ASK/OOK signals of the present invention only serves as a spectrum stretcher to widen the transmission spectrum so that the resulting transmission spectrum qualifies as spread spectrum transmission under FCC regulations. The actual data content pf the transmitted signals resides only in the ASK/OOK signal component. In one embodiment, the FSK component is of a random nature. That is, the FSK component contains random bit values. In accordance with the spread spectrum ASK/OOK transmission scheme of the present invention, the FSK component does not need to be detected by the receiver as it does not contains the actual data values. Therefore, the receiver can be implemented as a standard superheterodyne ASK receiver which typically has simple hardware construction.

In the present description, frequency-shift keying (FSK) refers to frequency modulation in which the modulating signal shifts the output frequency between predetermined values. Usually, the instantaneous frequency is shifted between two discrete values. In accordance with the present invention, a FSK modulator receives an input bit sequence and shifts the output frequency of the modulating signal between two discrete values in accordance with the input bit sequence. The input bit sequence can be a repeating data pattern such as “101010” or the bit sequence can be of a random nature, such as a pseudo-random (PN) bit sequence.

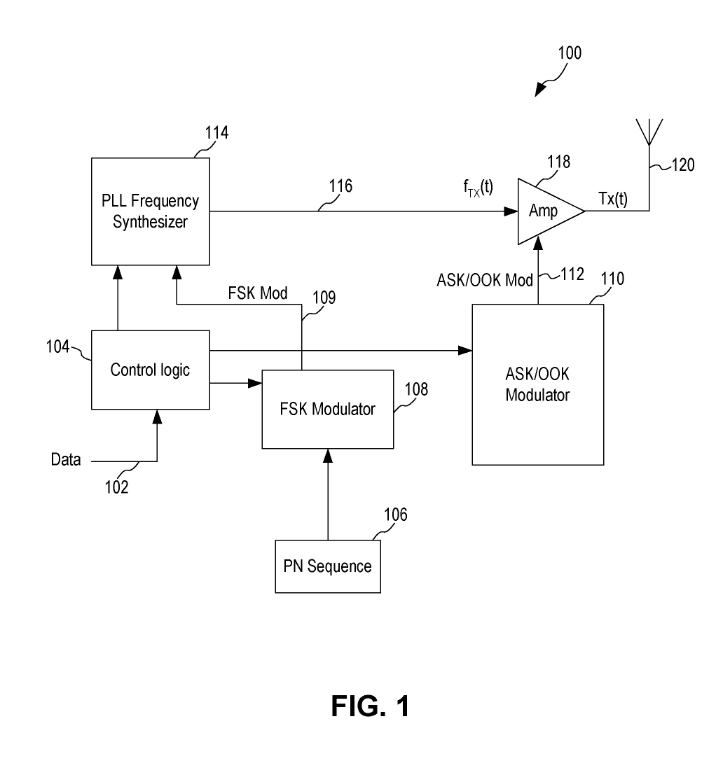

FIG. 1 is a block diagram of a spread spectrum ASK/OOK transmitter according to one embodiment of the present invention. Referring to FIG. 1, spread spectrum ASK/OOK transmitter 100 receives input data on a terminal 102 and generates transmitted signals Tx(t) for transmission via antenna 120 at a predetermined power level.

To operate in 902-928 MHz North American ISM band with an output power greater than −1 dBm, FCC regulations require the transmitter to implement some sort of frequency spreading. According to FCC 15.247 digital modulation, an intended radiator can operate on a single frequency if the occupied bandwidth is greater than 500 kHz with a peak power spectral density less than 8 dBm in any 3 kHz band during any time interval of continuous transmission. As Amplitude shift keying is by nature narrow banded, an ASK intended radiator system operating under FCC 15.247 will require some sort of frequency spreading.

In accordance with the spread spectrum ASK/OOK transmission scheme of the present invention, input data is encoded into an ASK/OOK baseband signal and the baseband signal modulates a carrier signal by changing the amplitude of the carrier signal. When OOK modulation is used, the carrier signal is turned on or off by the baseband signal to indicate a binary one or zero in the input data content. The spread spectrum ASK/OOK transmission scheme of the present invention applies FSK modulation to modulate the carrier frequency using a two-tone FSK signal. The FSK modulated carrier signal is set to have a frequency deviation exceeding the occupied bandwidth requirement of greater than 500 kHz under the FCC regulations. Accordingly, under the spread spectrum ASK/OOK transmission scheme of the present invention, the input data is applied to the FSK modulated carrier signal using ASK/OOK modulation to generate a transmitted signal having wide transmission spectrum meeting the spread spectrum transmission requirements under the FCC.

Turning again to FIG. 1, spread spectrum ASK/OOK transmitter 100 includes a control logic block 104, a pseudo-random bit sequence (PN Sequence) generator block 106, a FSK modulator 108, a phase-locked loop (PLL) frequency synthesizer 114, an ASK/OOK modulator 110 and an output power amplifier 118. Control logic block 104 receives the input data on terminal 102 and generates control signals for controlling PLL frequency synthesizer 114, FSK modulator 108 and ASK/OOK modulator 110. Control logic block 104 also provides the input data to ASK/OOK modulator. In accordance with the present invention, spread spectrum ASK/OOK transmitter 100 performs two modulation operations. First, PLL frequency synthesizer 114 provides a narrowband carrier signal which is modulated by the FSK modulator 108 to form a FSK-dithered wideband carrier signal f_{TX}(t) on a node 116. Second, the ASK/OOK modulator 110 amplitude modulates the wideband carrier signal f_{TX}(t) to generate the transmission signal Tx(t) encoding the desired input data. The transmission signal Tx(t), amplified by power amplifier 118, can then be emitted through antenna 120.

More specifically, the wideband carrier signal f_{TX}(t) on node 116 is generated as follows. First, PLL frequency synthesizer 114 generates a narrowband carrier signal with frequency spectrum determined by phase noise. Second, PN sequence generator 106 provides a pseudo-random data bit sequence to FSK modulator 108. In the present embodiment, a pseudo-random bit sequence is supplied to the FSK modulator 108 to use as the FSK modulation data pattern. In other embodiments, other data patterns can be provided to the FSK modulator 108. For example, a repeating data pattern, such as a “1010” data pattern, can be used as the data pattern to the FSK modulator. The exact nature of the data bit sequence provided to FSK modulator 108 is not critical to the practice of the present invention. Although a repeating data pattern or a random data pattern can be provided to FSK modulator 108, the use of a random data pattern provides certain advantages. For instance, a random data pattern has the advantage of resembling white noise so that the FSK modulation data pattern does not interfere with the actual data content. In one embodiment, to achieve data whitening, a 15-bit PN sequence is provided as the FSK modulation data pattern.

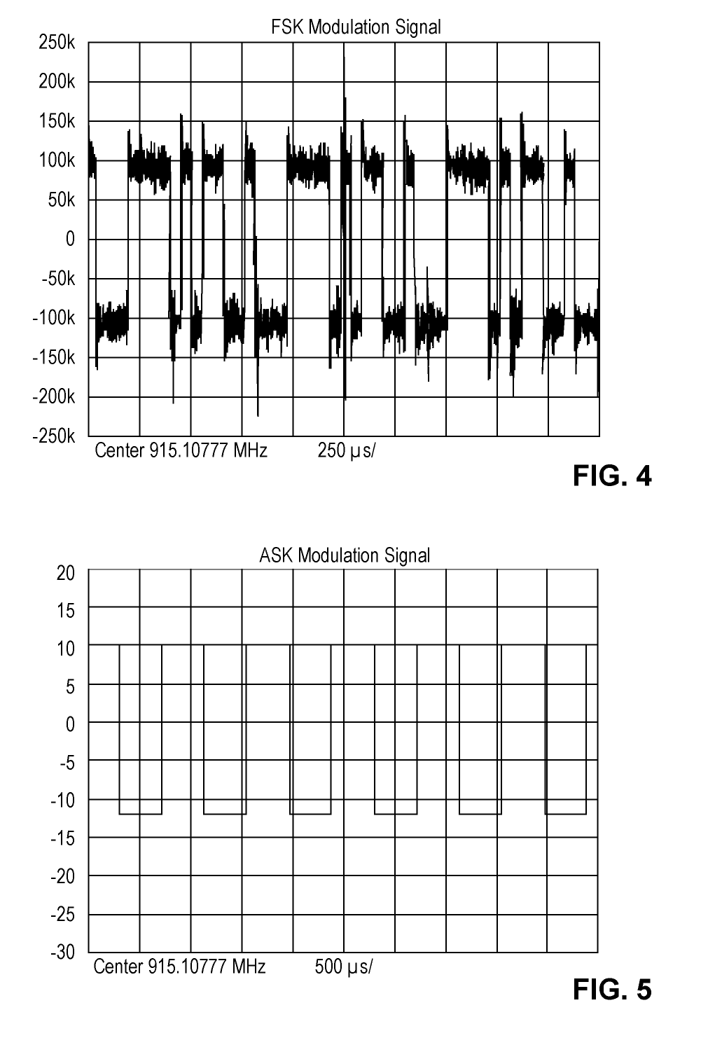

Third, the FSK modulator 108 encodes the PN bit sequence into a high frequency FSK modulation signal, as shown in FIG. 4. In the present embodiment, the FSK modulation signal is a signal that switches between the logical “hi” and logical “lo” values at a high frequency according to the PN bit sequence. As shown in FIG. 4, because the PN bit sequence is pseudo-random, the FSK modulation signal switches between logical “hi” and logical “low” values in a random nature.

Then, the FSK modulation signal (on a node 109) is coupled to dither the carrier frequency of the narrowband carrier signal of PLL frequency synthesizer 114. In this manner, FSK modulator 108 dithers the carrier frequency of the narrowband carrier signal in accordance with the data pattern of the PN bit sequence. In operation, the FSK modulator 108 shifts the carrier frequency of the narrowband carrier signal between two frequency values in accordance with the FSK modulation signal, thereby turning the narrowband carrier signal into the wideband carrier signal f_{TX}(t) on node 116.

At this point, FSK modulation has been applied to dither the carrier frequency of the carrier signal so as to generate the wideband carrier signal f_{TX}(t). The wideband carrier signal f_{TX}(t) is coupled to power amplifier 118 to be amplified. The wide band carrier signal f_{TX}(t) is now modulated by the ASK/OOK modulator 110 to encode the desired data content before being emitted through antenna 120 at a predetermined power level as the transmission signal Tx(t).

At the ASK/OOK modulator 110, the input data is encoded into an ASK/OOK modulation signal as the baseband signal, as shown in FIG. 5. As shown in FIG. 5, an ASK/OOK modulation signal switches between two logical states (“hi” or “lo”) to represent the two binary states of the input data. The ASK/OOK modulation signal is provided on a node 112 to drive the power amplifier 118. In the present embodiment, the ASK/OOK modulation signal controls the bias current supplied to the power amplifier to cause the power amplifier to turn on or off. By turning the power amplifier 118 on and off, transmitter 100 either transmits the high frequency signal carrier signal f_{TX}(t) or transmits no signal. The ASK/OOK modulated transmission signal Tx(t) is thus generated.

In accordance with the present invention, the shifting or dithering of the carrier frequency of the carrier signal by FSK modulator 108 is at a much higher data rate than the data rate of the ASK modulation signal. When the FSK modulation signal has a much high data rate than that of the ASK/OOK modulation signal, the spectrum density of the ASK/OOK modulation signal is not corrupted or degraded. In one embodiment, the FSK modulation signal is at least 20 GHz times higher than the ASK modulation signal.

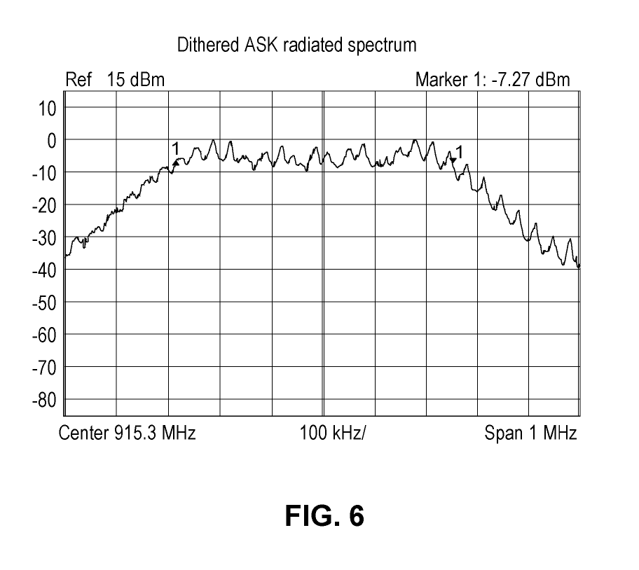

FIG. 6 is a frequency spectrum of an FSK-dithered spread spectrum ASK/OOK transmission signal when the FSK modulation signal of FIG. 4 is applied to the ASK modulated signal of FIG. 5. As shown in FIG. 6, the resulting spectrum of the ASK/OOK transmission signal of the present invention has an occupied bandwidth of greater than 500 kHz, allowing an OOK/ASK signal with an output power up to 8 dBm/3 kHz to be used for transmission.

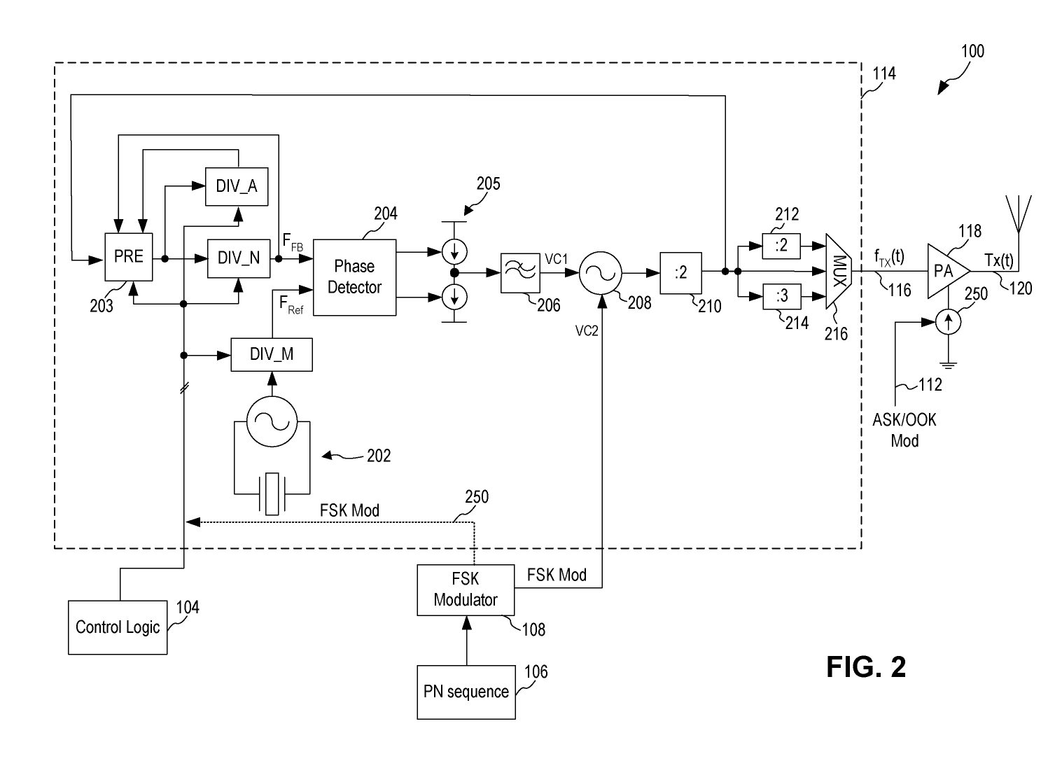

FIG. 2 is a detail schematic diagram of a spread spectrum ASK/OOK transmitter according to one embodiment of the present invention. Like elements in FIGS. 1 and 2 are given like reference numerals to simplify the discussion. FIG. 2 provides a detail schematic diagram of a PLL frequency synthesizer which can be used to implement PLL frequency synthesizer 114 of ASK/OOK transmitter 100 of FIG. 1. FIG. 2 further illustrates the connection of the PLL frequency synthesizer to other circuit blocks of the spread spectrum ASK/OOK transmitter of the present invention. In particular, FIG. 2 illustrates the application of the FSK modulation signal to dither the carrier signal generated by the PLL frequency synthesizer.

A phase-locked loop (PLL) is an electrical circuit that controls an oscillator so that the oscillator maintains a constant phase angle relative to a reference signal. Referring to FIG. 2, PLL frequency synthesizer 114 includes a phase detector 204, a charge pump 205, a low pass filter 206 and a voltage-controlled oscillator (VCO) 208 connected in a negative feedback configuration. VCO 208, receiving a first control voltage VC1 generated by charge pumps 205 and filtered by low pass filter 206, generates a clock signal which forms the basis of the narrowband carrier signal f_{TX}(t) of the ASK/OOK transmitter 100. The carrier signal is fed back through the feedback path to be coupled to the phase detector 204 as the feedback frequency signal F_{FB}. A crystal oscillator 202 generates a reference frequency signal F_{Ref} for the phase-locked loop and the reference frequency signal F_{Ref} is coupled to the phase detector 204. In the present embodiment, VCO 208 receives a second control voltage VC2 which is the FSK modulation signal from FSK modulator 108. The FSK modulation signal (or second control voltage VC2) operates to dither the output frequency of VCO 208 in order to stretch the frequency spectrum of the output carrier signal.

In PLL frequency synthesizer 114, a set of programmable frequency dividers DIV_M, DIV_N and DIV_A is included in the feedback path and the reference path so as to make the clock signal of the PLL a multiple of the reference frequency. In ASK/OOK transmitter 100, programmable frequency dividers DIV_M, DIV_N and DIV_A are controlled by control signals from control logic block 104. Furthermore, in the present embodiment, a dual modulus prescaler 203 is also included in the feedback path. A second set of frequency dividers (210, 212, 214) and a multiplexer 216 are coupled to the output of VCO 208 to generate the final output carrier signal f_{TX}(t) of PLL frequency synthesizer 114.

The basic operation of PLL frequency synthesizer 114 is as follows. PLL frequency synthesizer 114 includes phase detector 204, low pass filter 206 and voltage-controlled oscillator (VCO) 208 placed in a negative feedback configuration. Prescaler 203 in the feedback path, which functions as a frequency divider, makes the PLL's output clock frequency a rational multiple of the reference clock frequency F_{Ref}. Prescaler 203 includes a programmable pulse swallowing counter to generate fractional multiples of the reference frequency out of the PLL. In the feedback path, the main frequency divider is split into two parts—a main divider DIV_N and an additional divider DIV_A which is much shorter than DIV_N. Both dividers are clocked from the output signal of the dual-modulus prescaler 203, but only the output of the DIV_N divider is coupled to the phase detector 204.

Initially, the prescaler 203 is set to divide by M+1. Both dividers DIV_N and DIV_A count down until DIV_A reaches zero, at which point the prescaler is switched to a division ratio of M. At this point, the divider DIV_N has completed A counts. Counting continues until DIV_N reaches zero, which is an additional N-A counts. At this point the cycle repeats. The VCO 208 generates a periodic output signal. When the VCO 208 is applied a voltage, it starts to generate a clock signal. As the prescaler 203 is programmed to a given frequency, the phase from the VCO 208 can fall behind that of the reference frequency provided by crystal oscillator 202. The, the phase detector 204 causes the charge pump 205 to change the control voltage, so that VCO 208 speeds up. Likewise, if the phase creeps ahead of the reference frequency, the phase detector 204 causes the charge pump 205 to change the control voltage to slow down the VCO. The low-pass filter 206 smoothes out abrupt changes in the control voltage generated by the charge pump 205.

More specifically, the output clock signal of VCO 208 is at nearly the same frequency as the reference frequency signal. If the phase of the output clock signal of VCO 208 falls behind that of the reference frequency signal, the phase detector 204 causes the charge pump 205 to change the first control voltage VC1 so that VCO 208 speeds up the output clock signal. Likewise, if the phase of the output clock signal of VCO 208 gets ahead of the reference frequency signal, the phase detector 204 causes the charge pump 205 to change the first control voltage VC1 so that VCO 208 slows down the output clock signal. In this manner, PLL frequency synthesizer 114 generates a narrowband carrier signal.

In accordance with the present invention, VCO 208 receives a second control voltage VC2 from FSK modulator 108. Thus, while the output clock frequency of VCO 208 is controlled by the phase-locked loop to be in phase with the reference frequency provided by crystal oscillator 202, the output clock frequency of VCO 208 is also dithered by the second control voltage VC2 which is the FSK modulation signal from FSK modulator 108. As shown in FIG. 4, the FSK modulator signal is a binary signal that switches in a random manner between a logical “hi” value and a logical “lo” value. Thus, the output clock frequency of VCO 208 is thereby shifted between two discrete frequency values as determined by the voltage levels of the FSK modulation signal. In this manner, the frequency spectrum of the VCO output clock signal is stretched.

In PLL frequency synthesizer 114, the output clock signal of VCO 208 is passed to a first divide-by-2 frequency divider 210 and the divided down clock signal is further coupled in parallel to two frequency dividers 212 and 214 used to generate two additional frequency bands. The output signal from frequency divider 210 is coupled as the select signal for multiplexer 216 which selects between the output signals from frequency dividers 212 and 214, depending on the desired frequency bands. Frequency dividers 210, 212 and 214 can have the same or different divider factors. The wideband carrier signal f_{TX}(t) is thus generated. In order to generate the FSK-dithered wideband carrier signal f_{TX}(t), the PLL response has to be faster than the data rate.

In spread spectrum ASK/OOK transmitter 100, the wideband carrier signal f_{TX}(t) is coupled to power amplifier 118 to be modulated by the ASK/OOK modulation signal (ASK/OOK Mod). In the present embodiment, the ASK/OOK modulation signal modulates the carrier signal by turning the bias current supplied to power amplifier 118 on and off. Thus, as illustrated in FIG. 2, the ASK/OOK modulation signal (on node 112) is coupled to a current source 250 which supplies the bias current to power amplifier 118. The ASK/OOK modulation signal turns current source 250 on and off so that the bias current is either provided to power amplifier 118 or is not provided. Transmitter 100 thus either emits a high frequency transmission signal or no signal at all as the transmission signal Tx(t).

In the above description, the FSK modulation signal from FSK modulator 108 is coupled to control VCO 208 in order to dither the output clock frequency of the VCO. In an alternate embodiment, the FSK modulation signal can be applied to prescaler 203 to realize the desired spectrum stretching, as illustrated by the dotted line 250 in FIG. 2. More specifically, in the alternate embodiment, prescaler 203 is a frequency divider with a programmable divider ratio and the FSK modulation signal is applied to prescaler 203 to vary the divider ratio of the frequency divider. In one embodiment, prescaler 203 includes two sets of frequency divider registers. One set of frequency divider registers is selected by a data value of “1” while the other set is selected by a data value of “0”. The control logic 104 switches between the two sets of divider registers according to the data value of the PN sequence encoded in the FSK modulation signal.

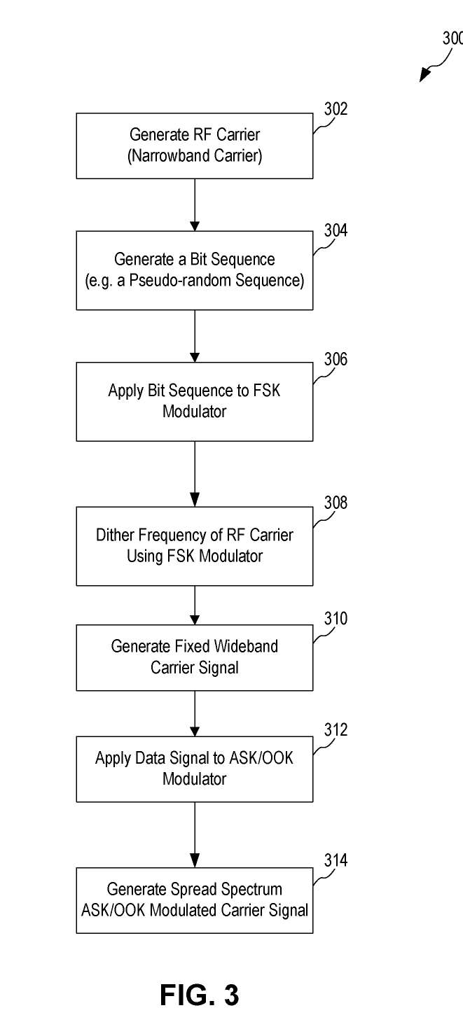

FIG. 3 is a flow chart illustrating the method of generating a FSK-dithered spread spectrum ASK/OOK transmissions signal using the spread spectrum ASK/OOK transmitter of FIGS. 1 and 2 according to one embodiment of the present invention. Referring to FIG. 3, method 300 stats by generating a RF carrier signal which is a narrowband carrier signal (step 302). In FIG. 2, the carrier signal is generated using frequency synthesis. In other embodiments, the narrowband carrier signal can be generated using frequency multiplication or directly through a high frequency resonator. The narrowband carrier signal has a frequency spectrum determined by phase noise.

Then, an input bit sequence is generated (step 304). In the present embodiment, the input bit sequence is a pseudo-random bit sequence. In other embodiments, the bit sequence can have a repeated data pattern. The bit sequence is applied to the FSK modulator at a high switching rate to generate the FSK modulation signal (step 306). The frequency of the FSK modulation signal is much higher than the frequency of the transmission signal containing the actual data content. The FSK modulation signal is then used to dither the frequency of the RF carrier signal (step 308). As a result, a fixed wideband carrier signal is generated (step 310). In the present description, the wideband carrier signal is fixed because the frequency of the carrier signal shifts between known frequency values.

To comply with FCC regulations in the North American 902-928 MHz ISM band, the 6 dB bandwidth of the transmitted spectrum must exceed 500 kHz. In one embodiment, the pseudo-random FSK modulation signal has a peak frequency deviation of minimum 250 kHz. In this manner, the wideband carrier signal complies with the FCC requirements.

At step 312, a data signal is applied to the ASK/OOK modulator to control the amplitude of the wideband carrier signal. The modulation of the wideband carrier signal by the ASK/OOK modulator provides a wideband carrier signal that is turned on/off or attenuated in accordance with the actual data to be transmitted. The FSK-dithered spread spectrum ASK/OOK transmission signal is thus generated (step 314).

The above description concerns the spread spectrum ASK/OOK transmitter of the present invention and the method of generating the spread spectrum ASK/OOK transmission signal. As described above, in accordance with the spread spectrum ASK/OOK transmission scheme of the present invention, the FSK component of the transmission signal does not need to be detected by the receiver as it does not contains any actual data values. Therefore, a receiver for use in the spread spectrum ASK/OOK transmission scheme of the present invention can be implemented as a standard ASK/OOK receiver. Thus, the use of FSK modulation for spectrum spreading does not add any complexity to the receiver design. In one embodiment, the receiver is implemented as a standard superheterodyne ASK receiver. As the spread spectrum ASK/OOK transmission signal has a very high FSK switching rate, a low-cost conventional ASK/OOK receiver with a noise bandwidth greater than 500 kHz can be used to demodulate the incoming carrier signal.

In one embodiment, the incoming carrier signal at the receiver is amplified, mixed down to a lower frequency or directly to the baseband frequency and is then applied to a conventional envelope or energy detector. The data content of the transmission signal is thus detected.

According to one aspect of the present invention, the spread spectrum ASK/OOK transmission scheme described above can be applied to a stand-alone transmitter or integrated with a receiver to form a transceiver. In one embodiment, the transmitter circuitry of the spread spectrum ASK/OOK transmitter of FIGS. 1 and 2 can be incorporated with the receiver circuitry to form a spread spectrum ASK/OOK transceiver.

The advantages of the spread spectrum ASK/OOK transmission scheme and the spread spectrum ASK/OOK transmitter/transceiver of the present invention are numerous. First, because the transmission scheme employs ASK/OOK modulation to encode actual data content, both the transmitter and the receiver or the transceiver can be implemented using simple and low cost circuit topology. Furthermore, the ASK/OOK transmitter or transceiver can realize a small current consumption budget as compared to other transmission schemes. The spread spectrum ASK/OOK transmitter or transceiver of the present invention enables the communication system to operate under the spread spectrum transmission standard under FCC part 15.247 without the need of frequency synchronization or complex demodulation or de-spreading required by other conventional transmission schemes.

Moreover, in accordance with the present invention, the direct sequence spread spectrum communication method is used instead of frequency hopping. A key benefit of the spread spectrum ASK/OOK technique of the present invention is that the RF carrier is kept fixed which simplifies the hardware design of the transmitter as well as the receiver. When frequency hopping is used as in the conventional systems, a lot of complexity is added to the transmitter and receiver design because of the need for frequency synchronization or de-spreading.

The above detailed descriptions are provided to illustrate specific embodiments of the present invention and are not intended to be limiting. Numerous modifications and variations within the scope of the present invention are possible. For example, in the present description, a PLL frequency synthesizer is used to generate the carrier signal. In other embodiments, other forms of frequency synthesizer or other frequency generation circuit can be used, as understood by one of ordinary skill in the art.

Moreover, in the above descriptions, the on-off keying form of amplitude-shift keying is described. In other embodiments, other forms of ASK modulation can be used to implement the data encoding modulation of the present invention. Also, the frequency dividers in the PLL frequency synthesizer are optional and can be omitted in other embodiments. Division factors other than 2 can also be used in other embodiments. The present invention is defined by the appended claims.

We claim:

1. An ASK/OOK transmitter comprising:
a frequency-shift keying (FSK) modulator receiving an input bit sequence and generating a FSK modulation signal indicative of the input bit sequence;
a frequency generation circuit receiving the FSK modulation signal and generating a carrier signal having a first frequency, the frequency of the carrier signal being shifted by the FSK modulation signal to form a wideband carrier signal;
an amplitude-shift keying (ASK) modulator receiving input data and generating an ASK modulation signal indicative of the input data; and
a power amplifier coupled to receive the wideband carrier signal as an input signal and the ASK modulation signal as a control signal, the power amplifier providing a spread spectrum ASK transmission signal, wherein the ASK modulation signal modulates the wideband carrier signal to form the spread spectrum ASK transmission signal.

2. The ASK/OOK transmitter of claim 1, wherein the wideband carrier signal has an occupied bandwidth of 500 kHz or more and the power amplifier provides the spread spectrum ASK modulation signal having an output power of or greater than −1 dBm.

3. The ASK/OOK transmitter of claim 2, wherein the FSK modulation signal has a peak frequency deviation that results in an occupied bandwidth of 500 kHz or greater.

4. The ASK/OOK transmitter of claim 1, wherein the FSK modulation signal generated by the FSK modulator has a higher frequency than the ASK modulation signal generated by the ASK modulator.

5. The ASK/OOK transmitter of claim 1, wherein the input bit sequence comprises a pseudo-random bit sequence.

6. The ASK/OOK transmitter of claim 1, wherein the input bit sequence comprises a bit sequence having a repeating data pattern.

7. The ASK/OOK transmitter of claim 1, wherein the ASK modulator comprises an amplitude-shift keying/on-off keying (ASK/OOK) modulator, the ASK/OOK modulator generating an ASK/OOK modulation signal indicative of the input data.

8. The ASK/OOK transmitter of claim 7, wherein the power amplifier is coupled to receive the wideband carrier signal and the ASK/OOK modulation signal and provide a spread spectrum ASK/OOK transmission signal, wherein the ASK/OOK modulation signal modulating the wideband carrier signal at the power amplifier by turning the wideband carrier signal on or off, thereby forming a spread spectrum ASK/OOK transmission signal.

9. The ASK/OOK transmitter of claim 8, wherein the ASK/OOK modulator controls the bias current supplied to the power amplifier, the ASK/OOK modulator turning the bias current on or off in accordance with the ASK/OOK modulation signal, thereby turning the power amplifier on or off to encode the input data in the wideband carrier signal.

10. The ASK/OOK transmitter of claim 1, wherein the frequency generation circuit comprises a frequency synthesizer.

11. The ASK/OOK transmitter of claim 1, wherein the frequency generation circuit comprises a phase-locked loop frequency synthesizer.

12. The ASK/OOK transmitter of claim 11, wherein the phase-locked loop frequency synthesizer comprises:
a voltage control oscillator (VCO) receiving a first control voltage and a second control voltage, the VCO providing an output clock signal, wherein the second control voltage is the FSK modulation signal;
a phase detector receiving a first clock signal indicative of the output clock signal of the VCO, a second clock signal indicative of a reference clock signal, the phase detector providing one or more signals indicative of the phase difference between the first and second clock signals;
a charge pump receiving the one or more signals of the phase detector and providing an output voltage; and
a low pass filter receiving and low pass filtering the output voltage of the charge pump to generate the first control voltage.

13. The ASK/OOK transmitter of claim 12, wherein the phase-locked loop frequency synthesizer further comprises:
a first frequency divider receiving the output clock signal of the VCO and dividing the output clock signal by a X factor to form the first clock signal;
a second frequency divider receiving the first clock signal and dividing the first clock signal by a Y factor to form a third clock signal;
a third frequency divider receiving the first clock signal and dividing the first clock signal by a Z factor to form a fourth clock signal; and
a multiplexer receiving the third and fourth clock signals as input signals and the first clock signal as the select signal, the multiplexer providing the wideband carrier signal as an output signal.

14. The ASK/OOK transmitter of claim 13, wherein factors X, Y and Z are different integers.

15. The ASK/OOK transmitter of claim 11, wherein the phase-locked loop frequency synthesizer comprises:
a voltage control oscillator (VCO) receiving a first control voltage and a second control voltage, the VCO providing an output clock signal, wherein the second control voltage is the FSK modulation signal;
a phase detector receiving a first clock signal indicative of the output clock signal of the VCO, a second clock signal indicative of a reference clock signal, the phase detector providing one or more signals indicative of the phase difference between the first and second clock signals;
a charge pump receiving the one or more signals of the phase detector and providing an output voltage;
a low pass filter receiving and low pass filtering the output voltage of the charge pump to generate the first control voltage; and
a frequency divider receiving the output clock signal of the VCO and generating the first clock signal having a frequency being a multiple of the frequency of the reference clock signal, the frequency divider having a programmable divider ratio where the divider ratio is varied according to the FSK modulation signal.

16. The ASK/OOK transmitter of claim 15, wherein the frequency divider comprises a first set of frequency divider registers and a second set of frequency divider registers, the FSK modulation signal operative to select between the first set and the second set of frequency divider registers.

17. The ASK/OOK transmitter of claim 1, wherein the frequency generation circuit generates the carrier signal having a first frequency using frequency multiplication or using a high frequency resonator.

18. A method of generating a spread spectrum ASK/OOK transmission signal comprising:
providing an input bit sequence;
generating a frequency-shift keying (FSK) modulation signal indicative of the input bit sequence;
generating a carrier signal having a first frequency;
shifting the frequency of the carrier signal using the FSK modulation signal to form a wideband carrier signal;
receiving input data;
generating an ASK modulation signal indicative of the input data; and
amplifying and modulating the wideband carrier signal using the ASK modulation signal, thereby generating a spread spectrum ASK transmission signal.

19. The method of claim 18, wherein the wideband carrier signal has an occupied bandwidth of 500 kHz or more and the spread spectrum ASK modulation signal has an output power of −1 dBm or greater.

20. The method of claim 19, wherein the FSK modulation signal has a peak frequency deviation that results in an occupied bandwidth of 500 kHz or greater.

21. The method of claim 18, wherein the FSK modulation signal has a higher frequency than the ASK modulation signal.

22. The method of claim 18, wherein the input bit sequence comprises a pseudo-random bit sequence or a bit sequence having a repeating data pattern.

23. The method of claim 18, wherein generating an ASK modulation signal indicative of the input data comprises generating an amplitude-shift keying/on-off keying (ASK/OOK) modulation signal indicative of the input data.

24. The method of claim 23, wherein amplifying and modulating the wideband carrier signal using the ASK modulation signal comprises turning on and amplifying the wideband carrier signal or turning off the wideband carrier signal in accordance with the ASK modulation signal, thereby generating a spread spectrum ASK transmission signal.
